(19) United States
(12) Patent Application Publication
(10) Pub. No.: US 2022/0308247 A1
(43) Pub. Date: Sep. 29, 2022

(54) THREE-MODE GEOMAGNETIC DETECTOR

(71) Applicant: HANGZHOU MOVEROAD TECHNOLOGY CO., LTD., Hangzhou, Zhejiang (CN)

(72) Inventors: Dapeng LI, Hangzhou, Zhejiang (CN); Bingda ZHONG, Hangzhou, Zhejiang (CN)

(73) Assignee: HANGZHOU MOVEROAD TECHNOLOGY CO., LTD., Hangzhou, Zhejiang (CN)

(21) Appl. No.: 17/610,931

(22) PCT Filed: Jul. 23, 2021
(86) PCT No.: PCT/CN2021/108114

§ 371 Date: Nov. 12, 2021

(30) Foreign Application Priority Data
Oct. 29, 2020 (CN) 202022457373.5

(51) Int. Cl. G01V 3/08; G08G 1/042; G08G 1/14

(52) U.S. Cl. CPC G01V 3/08; G08G 1/042; G08G 1/14

(57) ABSTRACT

A three-mode geomagnetic detector is provided. The detector includes an upper cover, a lower casing, and an inner container. A bottom of the inner container is detachably connected to a bottom of the upper cover, the inner container is sleeved within the upper cover, and the upper cover is snap-fitted to the lower casing. Through the design of the inner container, the use of an O-shaped sealing ring is avoided, such that poor sealing caused by the O-shaped sealing ring deformation due to vehicle rolling is avoided, and opening for replacement of components is convenient.

### TECHNICAL FIELD

The present disclosure relates to the field of parking space detection, and in particular relates to a three-mode geomagnetic detector.

### BACKGROUND ART

A geomagnetic parking space detector is embedded in the ground of parking space to detect whether there is a vehicle parked in the parking space. In order to prevent moisture from permeating into the detector and damaging components such as a battery, a capacitor, and a circuit board inside the detector. Generally, the detector includes a sealing device disposed outside the components such as the battery, the capacitor, and the circuit board.

In the related art, the sealing device includes an upper casing and a lower casing. A single O-shaped sealing ring is often used between the upper casing and the lower casing. When in use, the upper casing and the lower are assembled to compress and deform the O-shaped sealing ring, such that the O-shaped sealing ring clings to the upper casing and the lower casing for sealing.

However, there are at least the following problems in the prior art: 1. since an upper surface of the geomagnetic detector is basically flush with the ground when in use, the geomagnetic detector is often rolled by a vehicle; and when rolled, the O-shaped sealing ring will be deformed again, and when the vehicle leaves, the O-shaped sealing ring recover; in this dynamic deformation process, it is difficult to ensure that the seal ring is always clings to the upper casing and the lower casing, and the sealing effect cannot be guaranteed. 2. After the geomagnetic detector is sealed, it is not convenient to open and replace the components such as the internal battery, the capacitor and the circuit board.

### SUMMARY

The present disclosure aims to provide a three-mode geomagnetic detector to solve the above-mentioned problems. According to the present disclosure, through the design of an inner container, the use of an O-shaped sealing ring is avoided, such that poor sealing caused by the O-shaped sealing ring deformation due to vehicle rolling is avoided, and opening for replacement of components is convenient.

In order to solve the above-mentioned technical problems, the present disclosure provides the following technical solution. A three-mode geomagnetic detector is provided, which includes an upper cover, a lower casing, and an inner container. A bottom of the inner container is detachably connected to a bottom of the upper cover. The inner container is sleeved within the upper cover, and the upper cover is snap-fitted to the lower casing.

In some embodiments, the bottom of the inner container may be provided with a junction. The bottom of the upper cover may be provided with a mounting portion. The junction may be provided with first holes. The mounting portion may be provided with second holes aligned with the first holes, and the first holes and the second holes may be connected by first screws.

In some embodiments, the upper cover may be provided with an external thread. The lower casing may be provided with a plurality of protrusions for tightly clamping the external thread. The external thread may be snap-fitted to the protrusions.

In some embodiments, the inner container may be internally provided with supporting columns. A spacer may be arranged on the supporting columns. The spacer may be provided with third holes, which may be connected to the the supporting columns by second screws. Through the setting of the spacer and the supporting columns, a sensor and a component may be reasonably placed.

In some embodiments, the upper cover may be provided with a cover plate, and the cover plate may cover the lower casing.

In some embodiments, the cover plate may be provided with an indication mark for indicating an opening direction of the upper cover.

In some embodiments, the cover plate may be provided with a groove and a digital scale. Through the setting of the digital scale, how much the rotation has been made during mounting may be determined. Through the setting of the groove, the indication mark and the digital scale may be effectively protected.

In some embodiments, the lower casing maybe provided with uneven parts. Through the setting of the uneven parts, the friction may be increased, which makes it convenient for a user to grip and screw the upper cover.

In some embodiments, the upper cover may be made of a transparent material.

In some embodiments, the upper cover may be made of a transparent Polycarbonate (PC) material. The transparent PC material may be polycarbonate. Through the use of transparent PC material, it may be convenient to dispose photoreceptive sensors such as a photosensitive sensor in the inner container, and to view internal components by the upper cover.

The embodiments have the following beneficial effects:

Through the design of the inner container, the use of the O-shaped sealing ring is avoided, such that poor sealing caused by the O-shaped sealing ring deformation due to vehicle rolling is avoided, and opening for replacement of components is convenient.

### BRIEF DESCRIPTION OF THE DRAWINGS

FIG. 1 is an exploded view of the present disclosure.

FIG. 2 is a schematic structural diagram of the present disclosure.

FIG. 3 is a sectional view of FIG. 2.

FIG. 4 is a schematic structural diagram of a spacer.

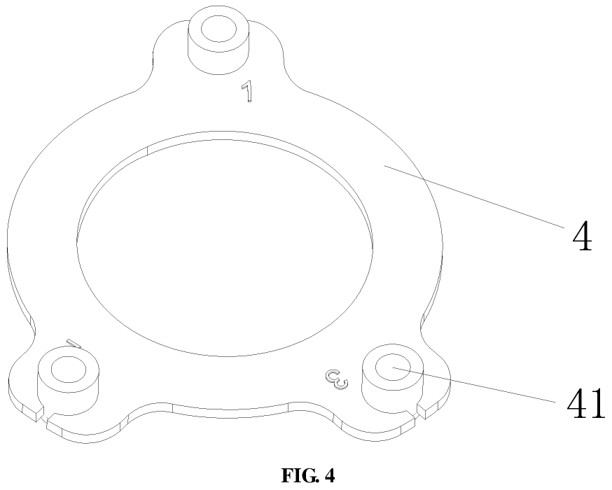

FIG. 5 is a schematic structural diagram of an inner container.

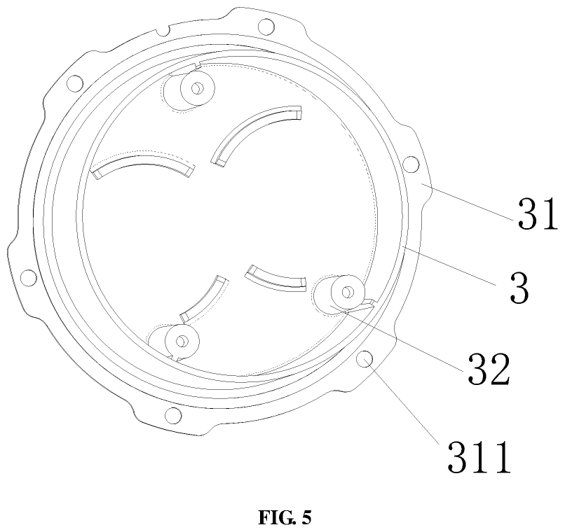

FIG. 6 is a schematic structural diagram of an upper cover.

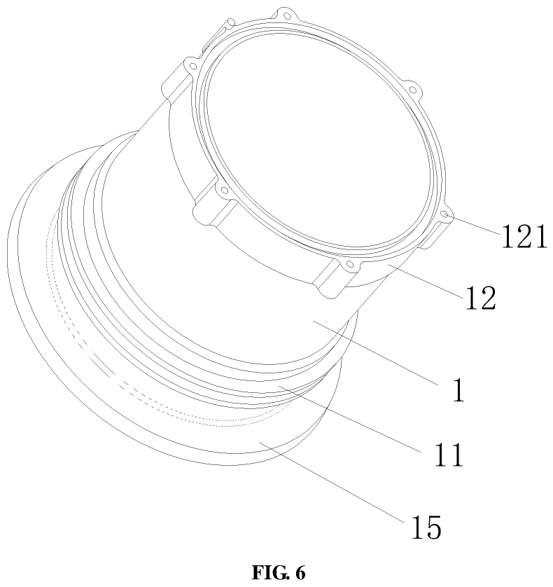

FIG. 7 is a schematic structural diagram of a lower casing.

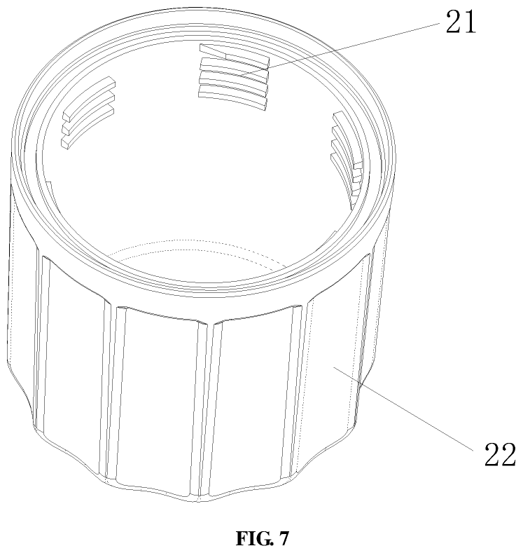

List of the reference characters: 1 upper cover; 11 external thread; 12 mounting portion; 121 second hole; 13 groove; 14 digital scale; 15 cover plate; 16 indication mark; 2 lower casing; 21 protrusion; 22 uneven part; 3 inner container; 31 junction; 311 first hole; 32 supporting column; 4 spacer; and 41 third hole.

### DETAILED DESCRIPTION OF THE EMBODIMENTS

The present disclosure will be further described below in conjunction with the drawings and implementations.

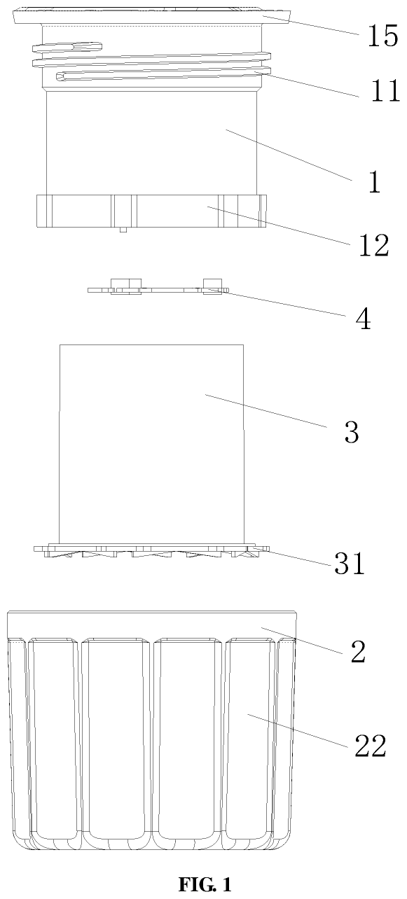

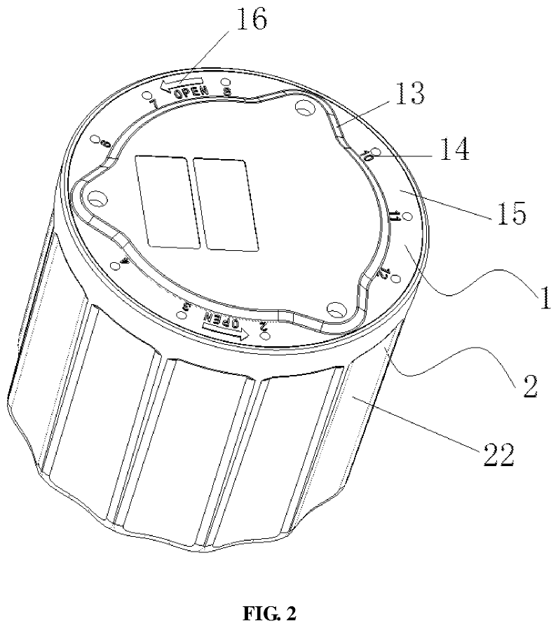

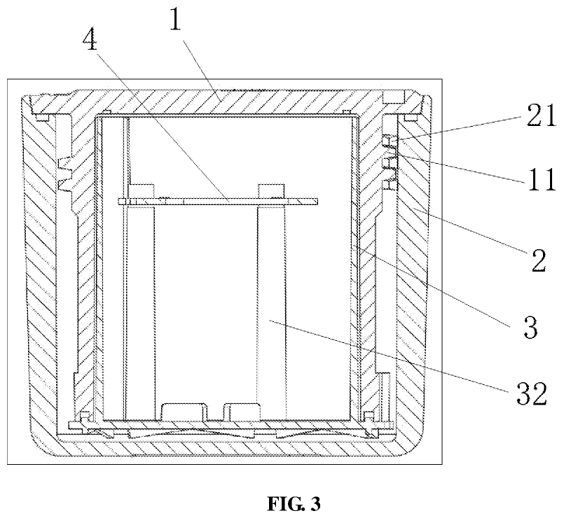

As shown in FIGS. 1 to 3, the embodiments provide a three-mode geomagnetic detector, which includes an upper cover 1, a lower casing 2, and an inner container 3. A bottom of the inner container 3 is detachably connected to a bottom of the upper cover 1. The inner container 3 is sleeved within the upper cover 1. The upper cover 1 is snap-fitted to the lower casing 2. The three-mode means that the geomagnetic detector is internally provided with three types of sensors, which are not shown in the embodiments.

The upper cover 1 is provided with an external thread 11. The lower casing 2 is provided with a plurality of protrusions 21 for tightly clamping the external thread 11. The external thread 11 is snap-fitted to the protrusion 21. The external thread 11 being snap-fitted to the protrusion 21 means that the external thread 11 is screwed and snap-fitted into the protrusion 21 such that the upper cover 1 is clamped to the lower casing 2 tightly.

The bottom of the inner container 3 is provided with a junction 31. The bottom of the upper cover 1 is provided with a mounting portion 12. The junction 31 is provided with first holes 311. The mounting portion 12 is provided with second holes 121 aligned with the first holes 311. The first holes 311 are connected to the second holes 121 by first screws.

The inner container 3 is internally provided with supporting columns 32. A spacer 4 is arranged on the supporting columns 32. The spacer 4 is provided with third holes 41, which are connected to the supporting column 32 by second screws. There are 3 the third holes 41 in the spacer 4, and there are 3 the supporting columns 32. Both the third holes 41 and the supporting columns 32 are arranged in a triangle shape, which makes the spacer more stable. The second screws pass through the third holes 41 and then enter into apertures provided in the supporting columns 32 to be fixed.

The upper cover 1 is provided with a cover plate 15, and the cover plate 15 covers the lower casing 2.

The cover plate 15 is provided with an indication mark 16 for indicating an opening direction of the upper cover 1.

The cover plate 15 is provided with a groove 13 and a digital scale 14.

The upper cover 1 is made of a transparent material.

The upper cover 1 is made of a transparent PC material.

The lower casing 2 is provided with uneven parts 22.

The various embodiments in the specification are described progressively, and each embodiment mainly illustrates the differences from other embodiments, and the same or similar parts among the various embodiments can be referred to each other.

The foregoing descriptions of the disclosed embodiments enables those skilled in the art to implement or use the present disclosure. Various modifications to these embodiments will be obvious to those skilled in the art, and general principles defined herein can be implemented in other embodiments without departing from the spirit or scope of the present disclosure. Therefore, the present disclosure shall not be limited to these embodiments shown herein, but should conform to the widest scope consistent with the principles and novel features disclosed herein.

1. A three-mode geomagnetic detector comprising an upper cover, a lower casing, and an inner container, wherein a bottom of the inner container is detachably connected to a bottom of the upper cover, the inner container is sleeved within the upper cover, and the upper cover is snap-fitted to the lower casing.

2. The three-mode geomagnetic detector according to claim 1, wherein the upper cover is provided with an external thread, the lower casing is provided with a plurality of protrusions for tightly clamping the external thread, and the external thread is snap-fitted to the protrusions.

3. The three-mode geomagnetic detector according to claim 1, wherein the bottom of the inner container is provided with a junction, the bottom of the upper cover is provided with a mounting portion, the junction is provided with first holes, the mounting portion is provided with second holes aligned with the first holes, and the first holes and the second holes are connected by first screws.

4. The three-mode geomagnetic detector according to claim 3, wherein the upper cover is provided with a cover plate, and the cover plate covers the lower casing.

5. The three-mode geomagnetic detector according to claim 1, wherein the inner container is internally provided with supporting columns, a spacer is arranged on the supporting columns, the spacer is provided with third holes, which are connected to the supporting columns by second screws.

6. The three-mode geomagnetic detector according to claim 5, wherein the cover plate is provided with an indication mark for indicating an opening direction of the upper cover.

7. The three-mode geomagnetic detector according to claim 6, wherein the cover plate (15) is provided with a groove and a digital scale.

8. The three-mode geomagnetic detector according to claim 1, wherein the upper cover is made of a transparent material.

9. The three-mode geomagnetic detector according to claim 8, wherein the upper cover is made of a transparent Polycarbonate (PC) material.

10. The three-mode geomagnetic detector according to claim 1, wherein the lower casing is provided with uneven parts.

11. The three-mode geomagnetic detector according to claim 2, wherein the bottom of the inner container is provided with a junction, the bottom of the upper cover is provided with a mounting portion, the junction is provided with first holes, the mounting portion is provided with second holes aligned with the first holes, and the first holes and the second holes are connected by first screws.

12. The three-mode geomagnetic detector according to claim 2, wherein the inner container is internally provided with supporting columns, a spacer is arranged on the supporting columns, the spacer is provided with third holes, which are connected to the supporting columns by second screws.

13. The three-mode geomagnetic detector according to claim 4, wherein the inner container is internally provided with supporting columns, a spacer is arranged on the supporting columns, the spacer is provided with third holes, which are connected to the supporting columns by second screws.

14. The three-mode geomagnetic detector according to claim 2, wherein the upper cover is made of a transparent material.

15. The three-mode geomagnetic detector according to claim 4, wherein the upper cover is made of a transparent material.

16. The three-mode geomagnetic detector according to claim 6, wherein the upper cover is made of a transparent material.

17. The three-mode geomagnetic detector according to claim 7, wherein the upper cover is made of a transparent material.

18. The three-mode geomagnetic detector according to claim 2, wherein the lower casing is provided with uneven parts.

19. The three-mode geomagnetic detector according to claim 4, wherein the lower casing is provided with uneven parts.

20. The three-mode geomagnetic detector according to claim 6, wherein the lower casing is provided with uneven parts.
